(19) United States
(12) Patent Application Publication
(10) Pub. No.: US 2018/0283727 A1
(43) Pub. Date: Oct. 4, 2018

(54) INTEGRATED ELEVATOR AND AIR CONDITIONING SYSTEM

(71) Applicant: Carrier Corporation, Jupiter, FL (US)

(72) Inventor: Michel Grabon, Bressolles (FR)

(21) Appl. No.: 15/762,678

(22) PCT Filed: Sep. 30, 2015
(86) PCT No.: PCT/IB2015/001976

§ 371 Date: Mar. 23, 2018

(51) Int. Cl. F24F 13/02; B66B 11/00; F24F 7/08

(52) U.S. Cl. CPC F24F 13/0227; B66B 11/0005; F24F 2007/001; F24F 2221/50; F24F 7/08

(57) ABSTRACT

An integrated air conditioning and elevator system of a building is provided. The system includes an air handling unit having a variable speed fan, a first elevator shaft configured to span a plurality of floors in the building, and a plurality of first dedicated variable speed fans located within the first elevator shaft, wherein one of the plurality of first variable speed fans is located at each of the plurality of floors and configured to fluidly connect the first elevator shaft with the respective floor of the plurality of floors. The variable speed fan of the air handling unit is configured to convey air to or from the first elevator shaft and each of the plurality of first variable speed fans is configured to convey air between the respective floor of the plurality of floors and the first elevator shaft.

### BACKGROUND

The subject matter disclosed herein generally relates to building systems and, more particularly, to integration of building elevator and air conditioning systems.

Buildings having multiple stories are configured with elevator systems for transporting occupants between floors of the building. The elevator system includes an elevator shaft through which elevator cars may operate in a vertical motion to transport occupants between floors.

Further, multiple story buildings are configured with air delivery systems and/or air conditioning systems that are configured to deliver fresh air to the various floors of the building. Ducting is used to bring treated, fresh air to a floor, usually originating at the roof or ground floor of the building. The air is then cycled out of the floors and exhausted out of the building, although in some configurations some of the exhaust air may be recycled to thermally treat the new incoming air.

### SUMMARY

According to one embodiment, an integrated air conditioning and elevator system of a building is provided. The system includes an air handling unit having a variable speed fan, a first elevator shaft configured to span a plurality of floors in the building, and a plurality of first dedicated variable speed fans located within the first elevator shaft, wherein one of the plurality of first variable speed fans is located at each of the plurality of floors and configured to fluidly connect the first elevator shaft with the respective floor of the plurality of floors. The variable speed fan of the air handling unit is configured to convey air to or from the first elevator shaft and each of the plurality of first variable speed fans is configured to convey air between the respective floor of the plurality of floors and the first elevator shaft.

In addition to one or more of the features described above, or as an alternative, further embodiments of the system may include a second elevator shaft configured to span the plurality of floors in the building and a plurality of second dedicated variable speed fans located within the second elevator shaft, wherein one of the plurality of second variable speed fans is located at each of the plurality of floors and configured to fluidly connect the second elevator shaft with the respective floor of the plurality of floors. Each of the plurality of second variable speed fans is configured to convey air between the respective floor of the plurality of floors and the first elevator shaft.

In addition to one or more of the features described above, or as an alternative, further embodiments of the system may include that the plurality of first variable speed fans are configured to convey air from the first elevator shaft onto the respective floor and the plurality of second variable speed fans are configured to convey air from the respective floor to the second elevator shaft.

In addition to one or more of the features described above, or as an alternative, further embodiments of the system may include a controller configured to operationally control the variable speed fan of the air handling unit and the plurality of first variable speed fans.

In addition to one or more of the features described above, or as an alternative, further embodiments of the system may include that the plurality of first variable speed fans are configured to convey air from the first elevator shaft onto the respective floor. The system further includes a duct system configured to exhaust air from each of the respective floors.

In addition to one or more of the features described above, or as an alternative, further embodiments of the system may include that the plurality of first variable speed fans are configured to convey air to the first elevator shaft from the respective floor. The system further includes a duct system configured to supply air to each of the respective floors.

According to another embodiment, a method of providing air conditioning within a building having multiple stories is provided. The method includes conveying intake air from an exterior of the building to a first elevator shaft of the building, the first elevator shaft spanning a plurality of floors in the building and distributing air from the first elevator shaft to each of the floors of the plurality of floors with a first dedicated variable speed fan located at each floor of the plurality of floors, wherein each of the plurality of first variable speed fans is configured to fluidly connect the first elevator shaft with the respective floor of the plurality of floors.

In addition to one or more of the features described above, or as an alternative, further embodiments the method may include conveying air from each of the respective floors to a second elevator shaft with a dedicated second variable speed fan located at each floor of the plurality of floors.

In addition to one or more of the features described above, or as an alternative, further embodiments the method may include at least one of expelling a portion of the air in the second elevator shaft out of the building or recycling the air in the second elevator shaft for air conditioning the intake air.

In addition to one or more of the features described above, or as an alternative, further embodiments the method may include that the plurality of first variable speed fans are configured to convey air from the first elevator shaft onto the respective floor and the plurality of second variable speed fans are configured to convey air from the respective floor to the second elevator shaft.

In addition to one or more of the features described above, or as an alternative, further embodiments the method may include conditioning the intake air prior to conveying the air into the first elevator shaft.

Technical effects of embodiments of the present disclosure include an integrated elevator and air conditioning system. Further technical effects include delivering and returning air for air conditioning within the elevator system, and specifically passing the air through the elevator shafts of the elevator system. Further technical effects include application of variable speed fans that are configured to maintain appropriate air pressure inside the elevator shaft and/or on the floors of the building.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of a multi-story building having an air conditioning system and an elevator system;

FIG. 2 is a schematic illustration of a multi-story building having an integrated air conditioning and elevator system in accordance with an embodiment of the present disclosure; and

FIG. 3 is a flow process for providing air conditioning within a building having multiple stories in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

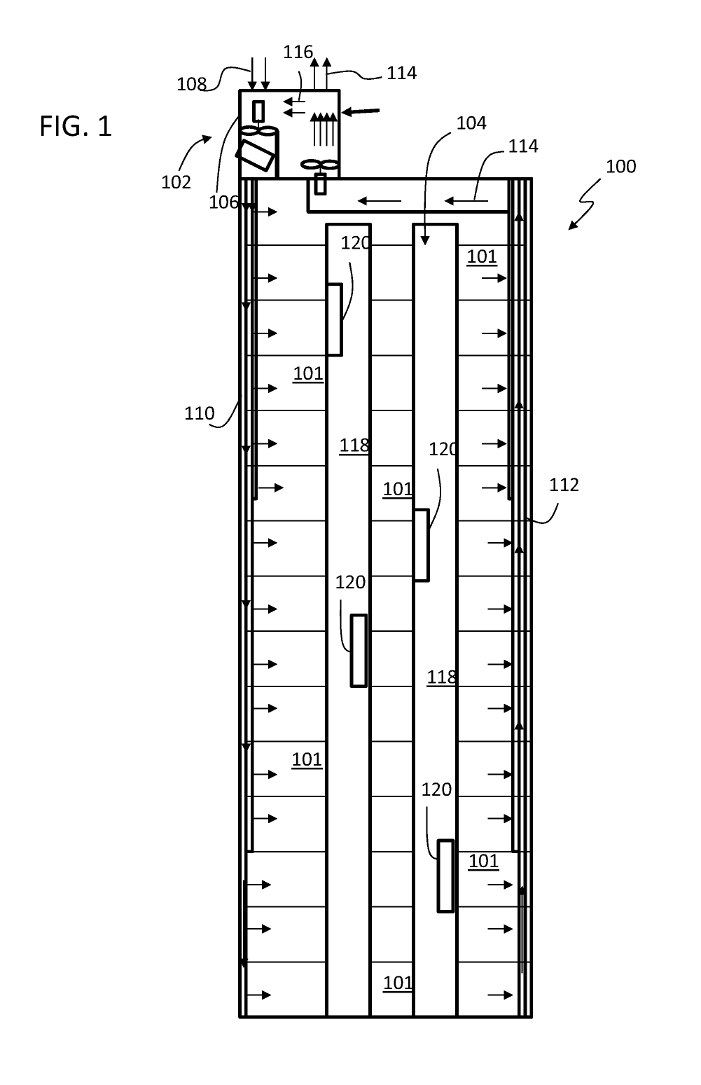

FIG. 1 is a configuration of a building having separate elevator and air conditioning systems. As shown, the building 100 includes a plurality of floors 101, an air conditioning system 102, and an elevator system 104.

The air conditioning system 102 includes an air handling unit 106, which may include air handling equipment. The air handling unit 106 may include fans, condensers, compressors, heat exchangers, etc. as known in the art. The air handling unit 106 may be configured to have intake air 108 be pulled into the air handling unit 106 and treated, such as adjusting the temperature, adding or removing moisture, etc. The treated air is then conveyed into a fresh air duct system 110. The fresh air duct system 110 is configured to convey fresh air into the floors 101 of the building 100. As the fresh air duct system 100 approaches the ground floor of the building, the ducting may be reduced in size. The fresh air duct system 110 may also include fans that are configured at each floor 101 of the building to convey an appropriate amount of the fresh air into the respective floor.

The fresh air will then flow through the respective floors 101 of the building 100, as indicated by the arrows shown in FIG. 1. The fresh air will then be impacted by the occupants of the building, e.g., polluted with carbon dioxide, etc., and will need to be exhausted from the floors. As such, the air conditioning system 102 includes an exhaust air duct system 112 that may be similar to the fresh air duct system 110. The exhaust air duct system 112 is configured to convey exhaust 114 air back to the air handling unit 106 with the exhaust air 114 being exhausted from the building. Further, in some configurations, a portion of the exhaust air 114 may be used as recycled air 116 to assist in treating the intake air 108.

Separate from the air conditioning system 102 is the elevator system 104. The elevator system 104 includes one or more elevator shafts 118. Each elevator shaft 118 may have one or more elevator cars 120 movable within the respective elevator shaft 118.

The combination of the air conditioning system 102 and the elevator system 104 may occupy a significant amount of space within the building 100, and thus the space that may be usable by occupants may be reduced. Further, as known in the art, the air conditioning system 102 may include fire protection systems that are configured to prevent fire and/or smoke from traveling or spreading between floors 101 of the building 100, and thus each of the floors 101 may be configured to be isolated from the other floors 101 in the event of an emergency.

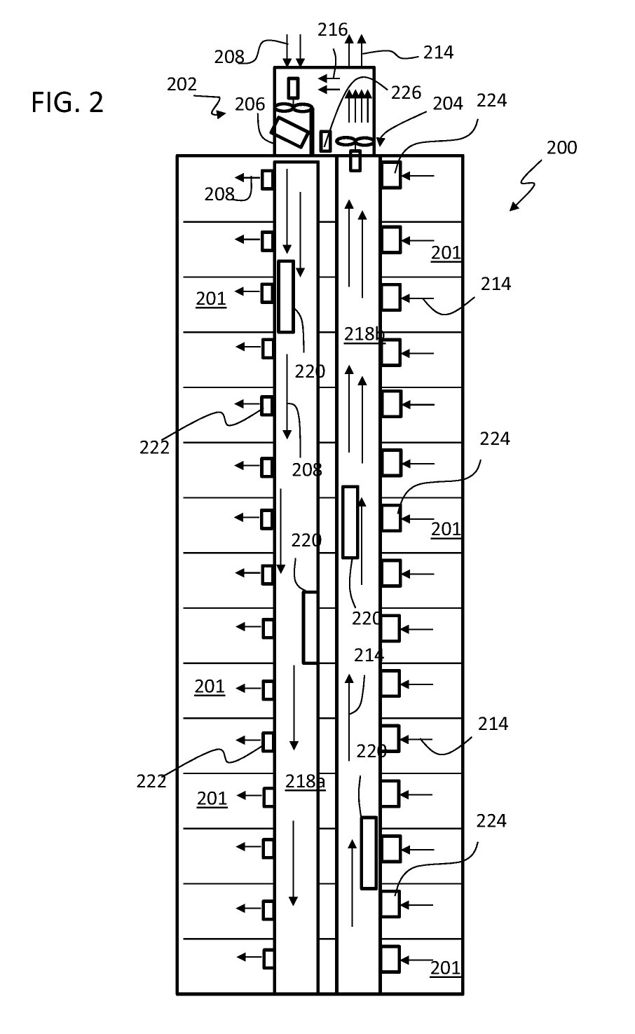

Turning now to FIG. 2, a building 200 configured in accordance with an embodiment of the present disclosure is shown. Building 200 is similar to building 100 of FIG. 1, but instead of two separate systems (e.g., air conditioning system 102 and elevator system 104) the air conditioning system 202 and the elevator system 204 are configured as an integrated system.

As shown, the air conditioning system 202 includes air handling unit 206, which may include variable speed fans, compressors, condensers, heat exchangers, etc. Intake air 208 is pulled into the building 200 by the air handling unit 206 and conveyed into a first elevator shaft 218a of the elevator system 204. The fresh intake air 208 then passes down the first elevator shaft 218a. The fresh intake air 208 is conveyed onto the floors 201 by operation of fresh air variable speed fans 222. The fresh air variable speed fans 222 are configured to pull air from the first elevator shaft 218a and disperse it onto a respective floor 201 of the building 200. The fresh air variable speed fans 222 are configured to fluidly connect the first elevator shaft 218a to a respective floor 201 of the building.

The air on the floors 201 of the building 200 will then become polluted by occupants of the building and thus become exhaust air 214. The exhaust air 214 may then be pulled by exhaust air variable speed fans 224 that pull the exhaust air 214 into a second elevator shaft 218b. The exhaust air 214 is then conveyed back to the air handling unit 206 where it may be exhausted from the building. Further, in some embodiments, a portion of the exhaust air 214 may be used as recycled air 216 such that the recycled air 216 is used to assist in treating intake air 208, e.g., during thermal treating of the intake air 208. The exhaust air variable speed fans 224 are configured to fluidly connect the respective floor 201 of the building with the second elevator shaft 218b.

As will be appreciated by those of skill in the art, the fresh air variable speed fans 222 and the exhaust air variable speed fans 224 may be configured to both maintain appropriate pressures on the respective floors 201 of the building 200 and maintain appropriate pressures within the first and second elevator shafts 218a, 218b. Further, the air handling unit 206 may include variable speed fans, both for intake and exhaust that are configured to maintain appropriate pressures within the first and second elevator shafts 218a, 218b.

Further, the fresh air variable speed fans 222 and the exhaust air variable speed fans 224 may be configured with fire protection. That is, in some embodiments, the fresh air variable speed fans 222 and the exhaust air variable speed fans 224 may be configured with fire protection dumpers or other devices and/or mechanisms to isolate a specific floor 201 in the event of an emergency. Further, the fresh air variable speed fans 222 and the exhaust air variable speed fans 224 may be configured with additional fire protection devices and/or mechanism that are configured to prevent a fire or smoke from entering the first and second elevator shafts 218a, 218b.

As shown in FIG. 2, the elevator cars 220 within the elevator shafts 218a, 218b are also exposed to the fresh intake air 208 in the first elevator shaft 218a and the exhaust air 214 in the second elevator shaft 218b. Thus, the elevator cars 220 may be configured with appropriate fans, filtration systems, or other mechanisms to ensure the air within a cabin of the elevator cars 220 is suitable for occupants of the elevator cars 220.

As will be appreciated, the air handling unit 206 may include a large variable fan for air intake, or multiple variable fans may be used for air intake. Similarly, a large (or multiple) variable exhaust fan may be installed in the air handling system 206. On each floor 201, dedicated fresh air variable speed fans 222 and the exhaust air variable speed fans 224 are configured for the specific floor 201.

Thus, the air handling system 206 may include a controller 226. The controller 226 may be configured to control and operate the variable speed fans in the air handling unit 206 and each of the fresh air variable speed fans 222 and the exhaust air variable speed fans 224. The controller 226 may be operably connected to each of the variable speed fans and may be in communication with one or more sensors (e.g., pressure sensors, carbon dioxide sensors, temperature sensors, etc.). The sensors may be integrated into the fresh air variable speed fans 222 and the exhaust air variable speed fans 224 at each floor 201. Further, one or more sensors may be configured within the elevator shafts 218a, 218b for the same purposes. Thus, the controller 226 may be configured to maintain predetermined or desired air conditioning at specific floors 201 within the building 200.

The controller 226 may be a computer or other controller as known in the art. The controller 226 may be in wired or wireless communication with the fresh air variable speed fans 222 and the exhaust air variable speed fans 224, the fans of the air handling unit 206, and with the sensors on each floor 201 and in the elevator shafts 218a, 218b. The controller 226 may further be configured to control the fresh air variable speed fans 222 and the exhaust air variable speed fans 224 in the event of an emergency to isolate one or more floors 201.

In some embodiments, the integrated air conditioning and elevator system described herein may be applied in buildings with five or more stories. Further, in some embodiments, if a building is configured with a single elevator shaft, systems described herein may be applied to provide intake air or exhaust air through the elevator shafts while the other of the intake air and the exhaust air is supplied through ducting. Thus, the total ducting within the building with only one elevator shaft may still benefit from embodiments described herein.

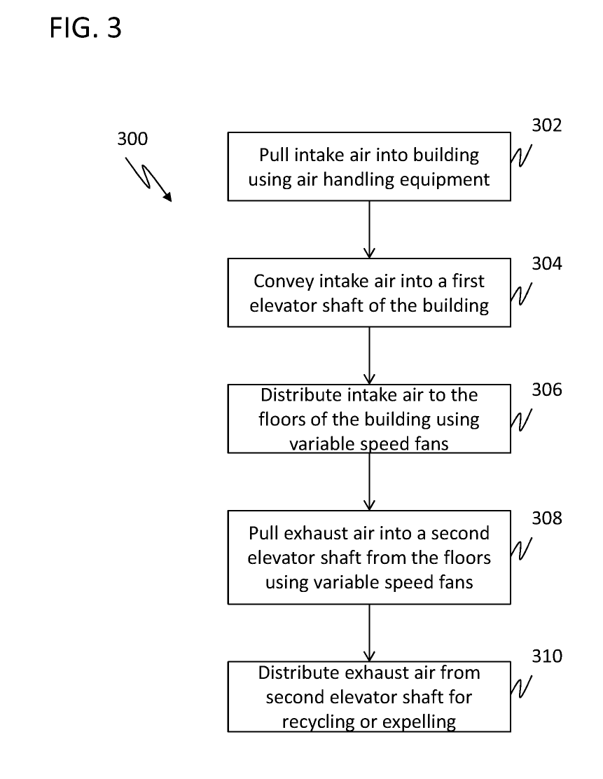

Turning to FIG. 3, a flow process in accordance with an embodiment of the present disclosure is shown. Flow process 300 is a process for providing air conditioning within a building having multiple stories and an elevator system, the air conditioning integrated with the elevator system, such as in the embodiments described above.

An air handling unit of the air conditioning system may pull intake air into the building using air handling equipment, as shown at block 302. The air handling unit may include one or more variable speed fans and a controller configured to control the variable speed fan. The intake air may be conveyed into a first elevator shaft of the elevator system, as shown at block 304. The intake air within the first elevator shaft may then be distributed to the floors of the building, as shown at block 306. The distribution to the individual floors may be enabled by a dedicated variable speed fan configured at each floor of the building and fluidly connecting the elevator shaft to the respective floor.

Dedicated variable speed fans may be configured on each floor of the building to pull exhaust air (i.e., carbon dioxide, polluted air) from each floor into a second elevator shaft of the building, as shown at block 308. The exhaust air may then be distributed by the air handling unit to either expel the exhaust air from the building or recycle the exhaust air in the air handling unit, as shown at block 310. Thus, flow process 300 may be used to supply air conditioned air to floors in a multi-story building with an integrated air condition and elevator system.

Advantageously, embodiments described herein provide an integrated air conditioning and elevator system. Further, advantageously, embodiments described herein enable reduced space requirements for air conditioning and elevator systems such that usable occupant space may be maximized in a building having multiple stories. Further, advantageously, embodiments described herein enable a relatively easy installation of two systems as an integrated system, thus requiring fewer components, less installation time and/or efforts, and/or lower costs.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although shown and described with a two-elevator shaft configuration, those of skill in the art will appreciate that embodiments described herein may apply to buildings having any number of elevator shafts. For example, as described above, buildings having a single elevator shaft may employ embodiments described herein. Further, buildings having more than two elevator shafts may employ embodiments described herein.

Accordingly, the present disclosure is not to be seen as limited by the foregoing description, but is only limited by the scope of the appended claims.

1. An integrated air conditioning and elevator system of a building, the system comprising:
an air handling unit having a variable speed fan;
a first elevator shaft configured to span a plurality of floors in the building; and
a plurality of first dedicated variable speed fans located within the first elevator shaft, wherein one of the plurality of first variable speed fans is located at each of the plurality of floors and configured to fluidly connect the first elevator shaft with the respective floor of the plurality of floors,
wherein the variable speed fan of the air handling unit is configured to convey air to or from the first elevator shaft, and
each of the plurality of first variable speed fans is configured to convey air between the respective floor of the plurality of floors and the first elevator shaft.

2. The system of claim 1, further comprising:
a second elevator shaft configured to span the plurality of floors in the building; and
a plurality of second dedicated variable speed fans located within the second elevator shaft, wherein one of the plurality of second variable speed fans is located at each of the plurality of floors and configured to fluidly connect the second elevator shaft with the respective floor of the plurality of floors,
wherein each of the plurality of second variable speed fans is configured to convey air between the respective floor of the plurality of floors and the first elevator shaft.

3. The system of claim 1, wherein the plurality of first variable speed fans are configured to convey air from the first elevator shaft onto the respective floor and the plurality of second variable speed fans are configured to convey air from the respective floor to the second elevator shaft.

4. The system of claim 1, further comprising a controller configured to operationally control the variable speed fan of the air handling unit and the plurality of first variable speed fans.

5. The system of claim 1, wherein the plurality of first variable speed fans are configured to convey air from the first elevator shaft onto the respective floor, the system further comprising:
a duct system configured to exhaust air from each of the respective floors.

6. The system of claim 1, wherein the plurality of first variable speed fans are configured to convey air to the first elevator shaft from the respective floor, the system further comprising:
a duct system configured to supply air to each of the respective floors.

7. A method of providing air conditioning within a building having multiple stories, the method comprising:
conveying intake air from an exterior of the building to a first elevator shaft of the building, the first elevator shaft spanning a plurality of floors in the building; and
distributing air from the first elevator shaft to each of the floors of the plurality of floors with a first dedicated variable speed fan located at each floor of the plurality of floors, wherein each of the plurality of first variable speed fans is configured to fluidly connect the first elevator shaft with the respective floor of the plurality of floors.

8. The method of claim 7, further comprising:
conveying air from each of the respective floors to a second elevator shaft with a dedicated second variable speed fan located at each floor of the plurality of floors.

9. The method of claim 7, further comprising at least one of expelling a portion of the air in the second elevator shaft out of the building or recycling the air in the second elevator shaft for air conditioning the intake air.

10. The method of claim 7, wherein the plurality of first variable speed fans are configured to convey air from the first elevator shaft onto the respective floor and the plurality of second variable speed fans are configured to convey air from the respective floor to the second elevator shaft.

11. The method of claim 7, further comprising conditioning the intake air prior to conveying the air into the first elevator shaft.
